(19) United States
(12) Patent Application Publication
(10) Pub. No.: US 2026/0187583 A1
(43) Pub. Date: Jul. 2, 2026

(54) LOGISTICS MANAGEMENT SYSTEM AND METHOD

(71) Applicant: Kai-Hoo Kenneth CHIU, Central (HK)

(72) Inventor: Kai-Hoo Kenneth CHIU, Central (HK)

(21) Appl. No.: 18/860,875

(22) PCT Filed: Jul. 3, 2024
(86) PCT No.: PCT/CN2024/103287

§ 371 Date: Oct. 28, 2024

Related U.S. Application Data
(60) Provisional application No. 63/524,723, filed on Jul. 3, 2023.

(51) Int. Cl. G06Q 10/083; G06Q 10/0631

(52) U.S. Cl. CPC G06Q 10/08355; G06Q 10/063114

(57) ABSTRACT

A logistics management system, includes: (i) an input unit for inputting delivery information of an order, the delivery information including at least a first location and a second location, and (ii) a processor in communication with the input unit, to confirm availability with a plurality of courier units and a plurality of vehicle units, and recommend a delivery route based on a correlation between the delivery information and the availability of the plurality of courier units and the plurality of vehicle units, the plurality of courier units including a plurality of first mile couriers and a plurality of last mile couriers, the delivery route including a first mile courier for collecting a shipment from the first location, a vehicle unit for receiving the shipment from the first mile courier and transporting the shipment, and a last mile courier for delivering the shipment from the vehicle unit to the second location.

### TECHNICAL FIELD

The present invention relates to a logistics management system and method. More particularly, the present invention relates to a logistics management system and method for recommending a delivery route for at least a delivery order.

### BACKGROUND

As a result of the COVID outbreak and the subsequent lockdown of most cities, a sudden surge in the use by shoppers of online shopping platforms has emerged, which has caused an increasing demand for last mile delivery of shopped articles from warehouses or retail outlets to households and offices. Further, the phenomenon of wholesalers downward expanding into offering online shops of their products to take advantage of engaging in direct sales to households has been noted.

The traditional large-scale logistics services cater for delivery of big lots of goods from wholesalers'warehouses to retailers to distribute or to retail businesses who consume the goods to produce other finished products. For packages of small lots of retail-sized goods, most vendors rely on local delivery services which serve specific cities or regions within a city. There are also crowd-sourced platforms mobilising the crowds to serve the last-mile delivery services.

Within the logistics industry there are typically two systems of distribution. One is the traditional fixed hub and spoke system as mentioned in Brimich Logistics Inc., The Hub And Spoke Distribution Model: Improved Logistics For Nearly Any Business (https://www.thebrimichgroup.com/hub-and-spoke-distribution-model/), that relies on providing one or more fixed points (each, a “hub”) for collecting the shipments of goods, where sorting, checking and repackaging may take place, and from the hub, different logistics service providers (each, a “spoke”, which radiate from the hub) will pick up their shipments and to deliver them to respective receivers. Depending on the area to be covered by the logistics company, there may be one central hub, or more central hubs each serving a predetermined sub-area within, or there may be the need to set up “mid-way hub” to facilitate mid-way stops for long distance travel for any of its employed vehicles and couriers. Under the fixed hub and spoke system, large amount of expenses is spent on leasing of the physical hubs and the employment of full-time staff to pick up shipments from each of the hubs and to deliver the last mile to the receivers.

Another more recent development is a point-to-point system that can rely on outsourced vehicles and couriers, in which each order is allocated to one specific vehicle (for long distance) or one specific courier (within walking distance). In this system, each vehicle and courier is assigned one or more delivery orders and without coordination of the delivery orders. Each of them may have travelled unnecessary distances. Besides, during their servicing time, they may not be carrying any shipments (e.g. when they are on their way to a pickup point to pick up a shipment, or on their return trip after they have finished delivering a shipment to a recipient) and much of their carrying capacity has not been fully utilized. Another problem faced by some current point-to-point systems is that it accepts the order from a sender and allocates it entirely to one vehicle even if the order includes deliveries of several shipments from, for example, one origin to several different destinations. The vehicle may even turn down the order request if the delivery addresses are too far apart for the vehicle to complete the trip without wasting too much time, fuel cost and road or tunnel fees.

There is also a missing piece in the market demands which has yet been fully catered for, and that is the delivery services of heavy and bulky goods from wholesalers or retailers to household customers in a reliable and cost-effective manner.

The existing local delivery services face difficulties such as the high labour costs to find the courier for carrying the heavy goods, resulting in a general reluctance of customers to bear the high costs for such courier services. These difficulties are more acute in densely populated cities with road systems which are complexed due to their long history. Hong Kong is a good example of such cities. The vehicle drivers often need to be accompanied by tag along couriers who travel with the vehicle to assist with onloading and offloading shipments from the vehicles. Sometimes, the vehicle drivers are the walkers too. They walk to the destination to deliver the shipment, and sometimes get parking tickets for offences. They often face the problems of finding the best spots to park their vehicles to allow sufficient time for their tag along couriers, or themselves, to offload the shipments from the vehicles and to walk to the destination household premises to deliver the shipments and to return to the vehicles for the next destination.

In general, the existing local logistics service providers also face problems of having idle and spare capacities in their delivery vehicles which, if used, may increase their income and to, in the long run, save on fuels (for vehicles) and energy (for couriers).

The existing crowd-sourced platforms focus on delivery of express and on-demand delivery of meals which are very different from the delivery of household goods which can be scheduled over a certain period of time and express delivery may not be critical. Such express delivery service is not the key focus of the present invention.

### SUMMARY OF THE INVENTION

According to a first aspect of the present invention, there is provided a logistics management system, comprising: (i) an input unit adapted for inputting delivery information of at least one order, wherein the delivery information of the order include at least a first location and a second location, and (ii) a processor in operative communication with the input unit, adapted to confirm availability with a plurality of courier units and a plurality of vehicle units, and recommend a delivery route for the order based on a correlation between the delivery information of the order and the availability of the plurality of courier units and the plurality of vehicle units, wherein the plurality of courier units further comprise a plurality of first mile couriers and a plurality of last mile couriers, wherein the delivery route comprises a first mile courier for collecting a shipment from the first location, a vehicle unit for receiving the item from the first mile courier and transporting the shipment, and a last mile courier for delivering the shipment from the vehicle unit to the second location.

In an embodiment, the delivery route includes at least a first delivery route for a first order and a second delivery route for a second order, wherein a first vehicle unit of the first delivery route is identical to a second vehicle unit of the second delivery route, and/or a first first mile courier of the first delivery route is identical to a second first mile courier of the second delivery route, and/or a first last mile courier of the first delivery route is identical to a second last mile courier of the second delivery route.

In an embodiment, the processor is adapted to allocate a predetermined first mile courier and a predetermined last mile courier to the order, based on the availability of the plurality of courier units within a predetermined period of time.

In an embodiment, the processor is adapted to classify the order into a first bundle based on the first location and a second bundle based on the second location, wherein each of the first and second bundles comprises at least one order with the first location or the second location located within a predetermined geographical area.

In an embodiment, the predetermined geographical area is in a size defined by a pre-determined diameter.

In an embodiment, the pre-determined diameter is 300 feet.

In an embodiment, the pre-determined geographical area is in a size accessible by the plurality of the courier units within a predetermined period of time.

In an embodiment, the geographical area comprises a first geographical area and a second geographical area, wherein the processor is adapted to allocate a predetermined vehicle unit to travel between at least the first geographical area and the second geographical area, and the vehicle unit is allocated to onload at least one shipment from at least one first mile courier at the first geographical area and to offload at least one shipment to at least one last mile courier at the second geographical area.

In an embodiment, the processor is adapted to determine one or more pick-up points where the vehicle unit onloads the at least one shipment from the at least one first mile courier, and one or more drop-off points where the vehicle unit offloads the at least one shipment to the at least one last mile courier.

In an embodiment, locations of the one or more pick-up points and drop-off points are determined by traffic data and/or road layout.

In an embodiment, locations of the one or more pick-up points and drop-off points are determined based on pre-used locations stored within the system.

In an embodiment, the system is adapted to assign a compass number for the order, wherein the compass number represents a direction of the second location relative to the first location.

In an embodiment, the system is adapted to allocate the vehicle unit to onload at least two shipments assigned with the same compass number.

In an embodiment, the order includes a first order and a second order, and the processor is adapted to allocate a first prospective trip a first vehicle unit of the first order and a second prospective trip to a second vehicle unit of a second order, wherein the processor is further adapted to revise the first and second prospective trips in response to predetermined conditions, by arranging the first and second vehicle units to meet at a predetermined meeting point where at least one shipment is transferred from the first vehicle unit to the second vehicle unit.

In an embodiment, the predetermined conditions are selected from change in traffic conditions, capacities of the vehicle units, or a combination thereof.

In an embodiment, the system further comprising an output unit adapted to output a respective prospective trip to each of the plurality of courier units and the plurality of vehicle units.

In an embodiment, the input unit is adapted for the plurality of courier units and the plurality of vehicle units to update their respective availability.

In an embodiment, the delivery information of the order further includes weight, size, sender information, recipient information, expected pickup time, expected delivery time, monetary value, or a combination thereof.

In an embodiment, each of the plurality of courier units is a person, a robot or a drone. In an embodiment, each of the plurality of vehicle units comprises one or more vehicles of transport modes selected from air, marine transport, land, or a combination thereof.

In an embodiment, the one or more vehicles are selected from a group of a van, an automobile, a bus, a ship, an airplane, a train, a truck, a bicycle, a motorcycle, a helicopter, a drone, or a combination thereof.

In an embodiment, each of the one or more vehicles has a coverage area defined by a predetermined radius.

In an embodiment, the predetermined radius is 500 m. In an embodiment, the vehicle unit comprises at least a first vehicle and a second vehicle, wherein the processor is adapted to arrange the first and second vehicles to meet for the shipment to be transferred from the first vehicle to the second vehicle.

In an embodiment, the system is accessible via an internet.

According to a second aspect of the present invention, there is provided a logistics management method, comprising steps of: (i) inputting delivery information of at least one order, wherein the delivery information of the order include at least a first location and a second location; (ii) confirming availability with a plurality of courier units and a plurality of vehicle units, wherein the plurality of courier units include a plurality of first mile couriers and a plurality of last mile couriers; and (iii) recommending a delivery route for the order, by correlating the delivery information of the order and the availability of the plurality of courier units and the plurality of vehicle units; wherein the delivery route comprises a first mile courier for collecting a shipment from the first location, a vehicle unit for receiving the shipment from the first mile courier and transporting the shipment, and a last mile courier for delivering the shipment from the vehicle unit to the second location.

In an embodiment, the delivery route includes at least a first delivery route for a first order and a second delivery route for a second order, wherein a first vehicle unit of the first delivery route is identical to a second vehicle unit of the second delivery route, and/or a first first mile courier of the first delivery route is identical to a second first mile courier of the second delivery route, and/or a first last mile courier of the first delivery route is identical to a second last mile courier of the second delivery route.

In an embodiment, the method further comprising a step of allocating a pre-determined first mile courier and a predetermined last mile courier to the order, based on the availability of the plurality of courier units within a predetermined time period.

In an embodiment, the method further comprising a step of grouping the order into a first bundle based on the first location and a second bundle based on the second location, wherein each of the first and second bundles comprises at least one order with the first location or the second location located within a predetermined geographical area.

In an embodiment, the predetermined geographical area is in a size defined by a pre-determined diameter.

In an embodiment, the pre-determined diameter is 300 feet.

In an embodiment, the pre-determined geographical area is in a size accessible by the plurality of courier units within a predetermined period of time.

In an embodiment, the geographical area comprises a first geographical area and a second geographical area, the method further comprising a step of allocating a predetermined vehicle unit to travel between at least the first geographical area and the second graphical area, wherein the vehicle unit is allocated to onload at least one shipment from at least one first mile courier at the first geographical area and to offload at least one shipment to at least one last mile courier at the second geographical area. In an embodiment, the method further comprising a step of determining one or more pick-up points where the vehicle unit onloads the at least one shipment from the at least one first mile courier, and one or more drop-off point where the vehicle unit offloads the at least one shipment to the at least one last mile courier.

In an embodiment, the method further comprising a step of interactively adjusting locations of the one or more pick-up points and drop-off points based on traffic data and/or road layout.

In an embodiment, the method further comprising a step of suggesting the locations of the one or more pick-up points and drop-off points are determined based on pre-used locations stored within the system.

In an embodiment, the method further comprising a step of assigning a compass number for the order, wherein the compass number represents a direction of the second location relative to the first location.

In an embodiment, the method further comprising a step to allocate the vehicle unit to onload at least two shipments assigned with the same compass number.

In an embodiment, the at least one order includes a first order and a second order, and a first prospective trip is allocated to a first vehicle unit of the first order and a second prospective trip is allocated to a second vehicle unit of a second order, the method further comprising the step of revising the first and second prospective trips in response to predetermined conditions, by arranging the first and second vehicle units to meet at a predetermined meeting point where at least one shipment is transferred from the first vehicle unit to the second vehicle unit.

In an embodiment, the predetermined conditions are selected from change in traffic conditions, capacities of the vehicle units, or a combination thereof.

In an embodiment, the method comprising a step of outputting a respective recommended route to each of the plurality of courier units and vehicle units.

In an embodiment, the delivery information of the order further include weight, size, sender information, recipient information, expected pickup time, expected delivery time, monetary value, or a combination thereof.

In an embodiment, each of the plurality of courier units is a person, a robot or a drone.

In an embodiment, each of the plurality of vehicle units comprises one or more vehicles of transport modes selected from air, marine transport, land, or a combination thereof.

In an embodiment, the one or more vehicles are selected from a group of a van, an automobile, a bus, a ship, an airplane, a train, a truck, a bicycle, a motorcycle, a helicopter, a drone, or a combination thereof.

In an embodiment, each of the one or more vehicles has a coverage area defined by a predetermined radius.

In an embodiment, the predetermined radius is 500 m.

In an embodiment, the vehicle unit comprises at least a first vehicle and a second vehicle, wherein the method further comprising a step of arranging the first and second vehicles to meet for the shipment to be transferred from the first vehicle to the second vehicle.

### BRIEF SUMMARY OF THE FIGURES

In order that a more precise understanding of the above-recited invention can be obtained, a more particular description of the invention briefly described above will be rendered by reference to specific embodiments thereof that are illustrated in the appended drawings. The drawings presented herein may not be drawn in scale and any reference to dimensions in the drawings or the following description is specific to the embodiments disclosed.

FIG. 1 is a schematic diagram of an embodiment of a logistics management system according to the present invention;

FIG. 2 is a schematic diagram of an embodiment of a delivery route according to the present invention;

FIG. 3 is a schematic diagram of two vehicles at two ends of a road where no crossings or U-turns are allowed;

FIG. 4 is a flowchart showing steps of proposing new pick-up points or drop-off points according to a method of the present invention;

FIG. 5 is a flowchart showing steps for updating a plurality of spatial pick-up locations stored in a database according to a method of the present invention;

FIG. 6 is a schematic diagram showing an assigned trip of a vehicle unit according to an embodiment of the present invention;

FIG. 7 is a diagram showing a compass in comparison to an actual trip of a vehicle unit according to an embodiment of the present invention;

FIG. 8 is a schematic diagram showing a distribution between a pick-up point and a plurality of first locations within a bundle according to an embodiment of the present invention;

FIG. 9 is a flowchart demonstrating an embodiment of a method for assigning courier units and vehicle units to each of the delivery orders according to the present invention;

FIG. 10 is a flowchart demonstrating an embodiment of a method for determining pick-up points and drop-off points of vehicle units according to an embodiment of the present invention;

FIG. 11 is a schematic diagram showing a plurality of trips assigned to the vehicle units according to an embodiment of the present invention;

FIG. 12 is a diagram demonstrating actions undergone by a system of the present invention in response to fluctuations in the density of orders, couriers, and vehicle drivers;

FIG. 13 is a diagram showing positive and negative responses to the historical performance of courier units according to an embodiment of the present invention;

FIG. 14 is a diagram showing positive and negative responses to the historical performance of vehicle drivers according to an embodiment of the present invention;

FIG. 15 is a diagram showing a comparison between an expected meeting time and arrival time for all stops in a delivery route according to an embodiment of the present invention;

FIG. 16 is a diagram showing positive and negative responses to the presence of other used meeting locations in the vicinity of the selected meeting location according to an embodiment of the present invention;

FIG. 17 is a schematic diagram showing an actual traffic situation where new pick-up points or drop-off points are proposed by a system according to an embodiment of the present invention;

FIG. 18 is a diagram showing positive and negative responses to the presence of any other prospective trips of vehicles with overlapping destination coverage areas according to an embodiment of the present invention;

### DETAILED SUMMARY OF THE EMBODIMENTS

An embodiment of the present invention relates to a logistics management system and method which at least ameliorates some of the problems faced by the skilled art, in particular, the courier persons and the delivery vehicle drivers.

According to an embodiment of the present invention, there is provided a system comprising: a back-end database of parameters of delivery orders with addresses which are building-specific, with a plurality of front-end user interfaces for the input of data by each of the participating courier units and vehicle units, which include a vehicle unit (impliedly, its driver making the decision), a first mile courier or a last mile courier; an interactive front-end user interface for delivery orders to be inputted by the sender and managed by the system; and a back-end computerized system to allocate jobs of delivery orders to the first mile courier, the last mile courier, and to group in bundles the jobs of pickup and delivery orders in a neighbourhood, to allocate the bundled jobs of pickup and delivery orders to a vehicle unit, to calculate and suggest the suitable pickup and drop off points interactively for each of the vehicle units and the couriers for each group of bundled jobs, to coordinate the prospective, and confirmed trips for each vehicle unit to align the start point, the meeting points and the end point for its allocated jobs of orders, to monitor each prospective, and confirmed trip, and to send feedback to all delivery courier units and vehicle units and receivers on time of any transfer and arrival of shipments of goods being delivered. In the context of the description, a shipment means the goods or items to be delivered in a delivery order.

The improvement of the present invention allows the system to arrange flexibly between the point-to-point system and the fixed hub and spoke system depending of the state of use of the system, and is equipped with technical features which help overcome the above identified problems in each of the two systems. The system arrangement of the present invention will be more like that of a point-to-point system when the system usage is low (defined to be a state in which no transfer agent's capacity is fully utilized), and more like the fixed hub and spoke system when the system usage is high (defined to be a state in which at least one transfer agent's capacity is fully utilized), yet without the use of any physical hubs.

### I. Basic Operation of The System, Accepts Delivery Orders, Allocate to a First Mile, Vehicle Unit Last Mile to Complete a Delivery Order

FIG. 1 shows an embodiment of a logistics management system 100 in accordance with the present invention. The system 100 is a centralised system that has the capability to process a plurality of delivery orders and coordinate a suitable delivery route in order to complete the delivery of the shipments within an expected delivery time. The processor 110 processes the locational information of a delivery order, including the origin (where it is picked up as designated by a sender) and the destination (as designated by the sender) of each shipment, such as an address and/or a GPS point, and then allocates three parties to deliver the shipment point-to-point from the address of the origin (i.e. the address to pickup the shipments) provided by the sender to the address of the destination of a recipient. These parties are the first mile couriers, the vehicle units and the last mile couriers. More particularly, upon the information of a delivery order inputted by a sender, the processor will first break up the information into 3 jobs:
(i.) a first job to be matched with a first mile courier who will pick up the shipment from the origin to a meeting point;
(ii.) a second job to be matched with a vehicle unit which will transport the shipment from a first meeting point to meet the first mile courier for onloading of the shipment to the vehicle unit, to a second meeting point to meet the last mile courier for offloading of the shipment to the last mile courier; and
(iii.) a third job to be matched with a last mile courier who will take the shipment from the second meeting point to the destination.

Referring to FIG. 1, the system 100 comprises an input unit 130 for inputting the delivery information 131 of the shipment, the availability information of courier units 133 and the availability information of the vehicle units 135 to the processor 110 for analysing and calculation in order to provide a match of the three parties with a recommendation of the coordinated delivery route to complete the delivery order. In an embodiment, the system 100 further includes a courier profile database for storing the availability information of courier units 133, and a vehicle unit profile database for storing the availability information of the vehicle units 135.

The delivery information includes a GPS point or an address of the origin provided by a sender where shipment is picked up from, and also a GPS point or an address of the destination where the shipment is delivered to. The exact location of the destination may be further adjusted by the recipient of the shipment. Other delivery information of the shipment may also be entered into the system 100 for more thorough analysis. The delivery information may include the description of the shipment, the weights, size and measurements of the shipment, the expected delivery time desired by the sender, the monetary values of the shipment items, or other useful information useful to the processor's 110 consideration in matching the jobs with the couriers and vehicle units.

The delivery route 140 of the present invention is achieved by the three parties—the first mile couriers, the last mile couriers and the vehicle units. The system 100 requires each of these three parties to input their availability and capability information including for example, their maximum carrying capacities, their preferred working neighbourhoods, their preferred working days of the week, their preferred working hours, their blocked-out dates, etc., for creating a unique availability profile for each of them. There are interfaces in the system for the couriers and vehicle units to log onto the system to update their profile.

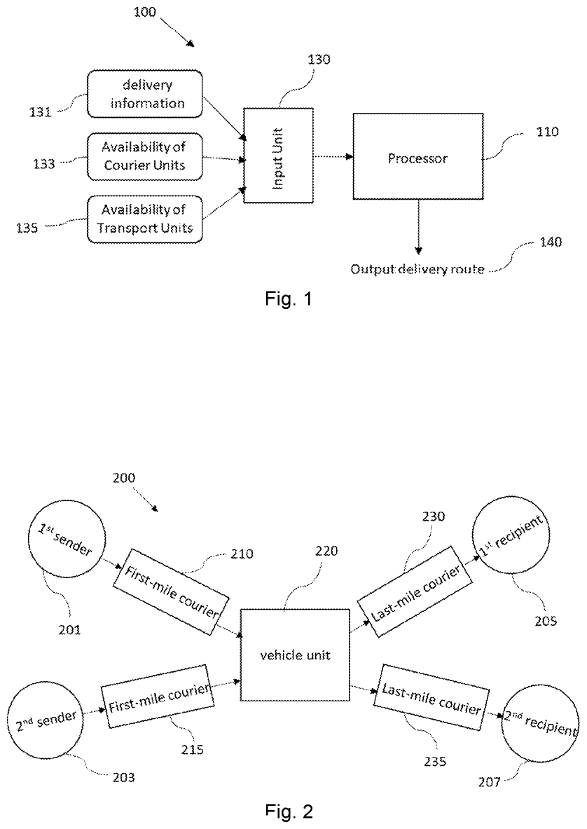

Referring now to FIG. 2, each of the first mile couriers 210, 215, the vehicle units 220 and the last mile couriers 230, 235 have different jobs along the delivery route 200. The first mile courier 210 is responsible for picking up a shipment from the origin, a first location provided by the sender 201 and delivering it directly to a vehicle unit 220 at a meeting point for onloading the shipments to the vehicle unit 220. The vehicle unit 220 is responsible for receiving the shipments from multiple first mile couriers 210, 215, and subsequently transport the shipments from at least a first area to a second area. Upon arriving at the second area, the last mile couriers 230, 235 are responsible for offloading the shipments from the vehicle 220 and deliver them respectively to the recipients 205,207 at the destinations.

The vehicle unit 220 includes one or more vehicles selected from the following categories: air, marine and land transports. Examples of vehicles include a van, an automobile, a bus, a ship, an airplane, a train, a truck, a bicycle, a motorcycle, a helicopter, a drone, etc. Depending on the load and the itineraries of the vehicles, the vehicle unit 220 may comprise more than one vehicle. In such cases, the vehicles are required to meet at a meeting point for the shipment to be transferred from a vehicle to another in order to continue with the trip.

### II. Building Clusters—Explanation How It Works in the System

The serviceable region by the system is divided into districts, which is in turn divided into sub-districts, which is in turn divided into neighbourhoods, and a neighbourhood is defined to be covering the specific building clusters (explained below). The jobs in the delivery orders received are processed so that they are each categorized and labelled accordingly by the locations of the origin and destination addresses (in terms of their longitude and latitude, or a GPS point). The system of the present invention is configured in such a way that delivery orders with the addresses of the origin within the same building cluster or within the same neighbourhood are grouped together for analysis, thus allowing them to be processed at the same time by the processor.

For example, based on the availability profile of the couriers in the system, the system will select the suitable first mile jobs within a building cluster or neighbourhood and send them to all couriers who match with the jobs. The first mile courier can choose and pick one or more of the displayed jobs. This reduces the necessary travelling time of any one courier to cross neighbourhoods to do the first mile jobs. Besides, a courier is familiar with the streets and roads and the traffic in his/her neighbourhood(s) and will be more efficient in staying within the neighbourhood to complete the jobs.

Furthermore, the system includes a further backend database for storing the locational information within a serviceable region. The backend database is configured to group buildings/houses within the serviceable region into a plurality of building clusters. Buildings/houses surrounded by the exact same group of roads and streets are grouped together in a uniquely identified building cluster. The permitted traffic conditions of the surrounding roads and streets are also profiled, including the direction of travel (e.g. one-way or two-way) to assist the system in identifying the local traffic routes and coordinating the trips for the vehicle units and also in suggesting the meeting points for couriers and vehicle units. A building cluster is a node in a mathematical graphical representation of the area and the streets and/or roads (together with identified one-way/two-way-traffic) around the building cluster are the paths linking the nodes. The nodes and the paths are used by the system processor 110 as the basic units and applying graph theory to plan the local traffic route for the vehicle units within the neighbourhood or sub-district.

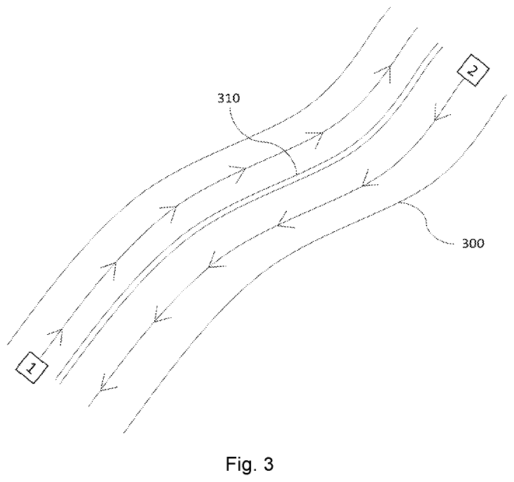

By way of illustration, referring now to FIG. 3, which shows two vehicle units 1 and 2 stopping at two ends of a two-way road 300 with a double line 310 between them, where no crossings or U-turns are allowed. The Euclidean distance between vehicle units 1 and 2 is short, but the design of the road and the traffic rules forbid vehicle 1 to drive directly to the position of vehicle 2 along the Euclidean distance, and so the two vehicles are separated by a large actual traffic distance. If one single vehicle unit is assigned to take up both jobs of collecting the shipments at points 1 and 2, much time will be wasted on traffic. Instead, the system will not select and display these two jobs to one single vehicle unit but will display the two jobs to more than one vehicle unit to allow different vehicle units taking up these two jobs.

### III. How First Mile Couriers Select the Location of the Meeting Point With Vehicle Unit

The system starts planning a prospective vehicle trip by first setting the first meeting point between the first mile courier and the vehicle unit. When a courier selects and picks a first mile job, the system takes notes of the location of the first mile courier, usually down to the building cluster and neighbourhood where the first mile courier specifies he will be situated at the specified date and time. The system will then check against its database for (i) the past used locations for onloading/offloading of shipments between any vehicle units and couriers, and (ii) the past used locations for onloading/offloading of shipments between any vehicle units and the first mile courier. The system comes up with 5 most frequently used past locations and proposes to the first mile courier. The first mile courier makes the selection of the best choice of the location and this is set as the first meeting point with a vehicle unit for the delivery route of the delivery order. If there are no used past locations in the system database that can be selected, or if the first mile courier does not prefer any of the choices proposed by the system, the first mile courier is prompted to make his proposed location to meet the vehicle unit, and to send this location to the system. The file mile courier can make the proposal by giving a name in text or by voice together with a pin on a map. The system will record the longitude and latitude of this location in its database of used past locations for future use.

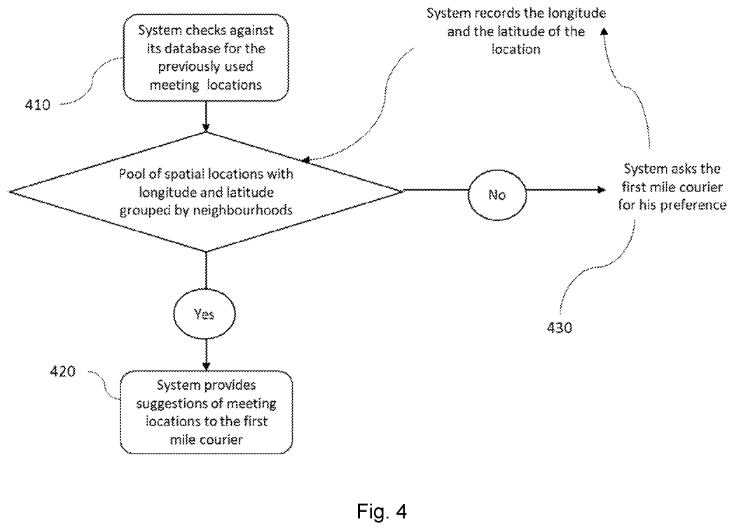

FIG. 4 is a flowchart demonstrating steps of this process, the method comprising the steps of:
Step 410—The system checks against its database for the previously used meeting locations.
Step 420—If there are previously used meeting locations stored in the database, the system will suggest them to the first mile couriers.
Step 430—If there are no previously used meeting locations stored in the database, the system asks the first mile courier for his preference and then records it in the system.

### IV. How System Selects Jobs to Send to Vehicle Units and How a Trip Is Formed by the System

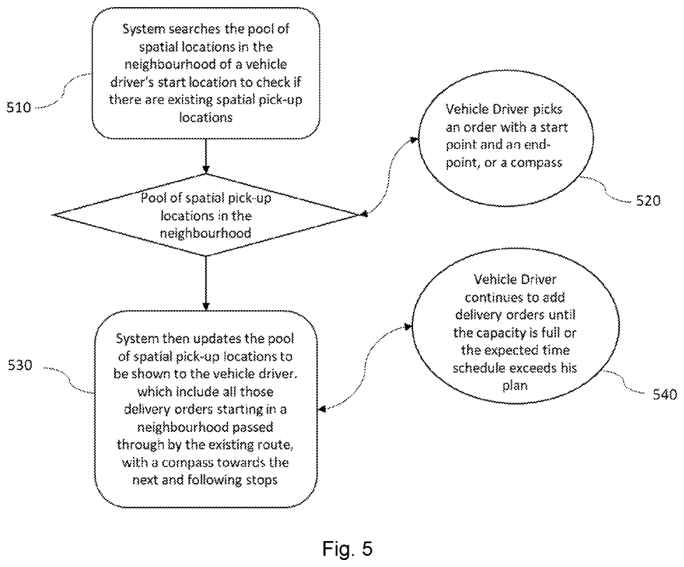

FIG. 5 is a flowchart showing the steps for requesting a vehicle unit to fill the vehicle unit with shipments of jobs of delivery orders, wherein the steps include Step 510-The system searches the pool of spatial locations in the vicinity of a vehicle unit's start location to check for existing spatial pick-up locations. A pick-up location turns up in a pool of pick-up locations only if and when a first mile courier has picked a first mile delivery job of and order, and chooses a meeting point with a vehicle.
Step 520—Vehicle units pick jobs from the pool of spatial pickup locations based on a start and end point, or a compass.
Step 530—The system then updates the pool of spatial pick-up locations to be displayed to the vehicle unit, which includes all those jobs of delivery orders that start in a neighbourhood passed by the existing route of the picked job, with the same or aligned compass number towards the next and subsequent stops.
Step 540—The vehicle unit continues to add jobs of delivery orders until the capacity is full or the expected time schedule exceeds his plan.

For a particular vehicle unit which has entered the system and registered their vehicle capacity and home address, their preferred rate of pay (monthly, daily or hourly), their last fuel bill (both cost and mileage), the system notes the driver's neighbourhood (usually down to a building cluster). The system selects from a database the spatial locations of pickup points that match and exceed the target vehicle unit's capacity, based on:
(i.) the vehicle unit's preferred route (including at least a start neighbourhood and a destination, and optionally an intermediate stop neighbourhood or sub-district) for the operation. The system assumes the preferred route ends at the starting location of the driver, unless the driver specifies otherwise.
(ii.) the vehicle unit's preferred time period for the trip, or
(iii.) whether the vehicle unit already has existing jobs, and if so, what the vehicle unit's spare capacity is, and what the existing job start and end points are, and if not, which district or neighbourhood the driver would like to start and finish in.

The system comes up with a pool of spatial locations (usually not more than 150% of the capacity or spare capacity of the vehicle unit) to be selected by the specific vehicle unit. The vehicle unit sends signals to the system by selecting a job of delivery order. The system then sends signals to the vehicle unit to pick up jobs of delivery orders with the same compass number starting in the same neighbourhood, or in the neighbourhoods, sub-districts or districts through which the route of the first selected job of delivery order will pass, or in the neighbourhood of the destination of the job of the first delivery order.

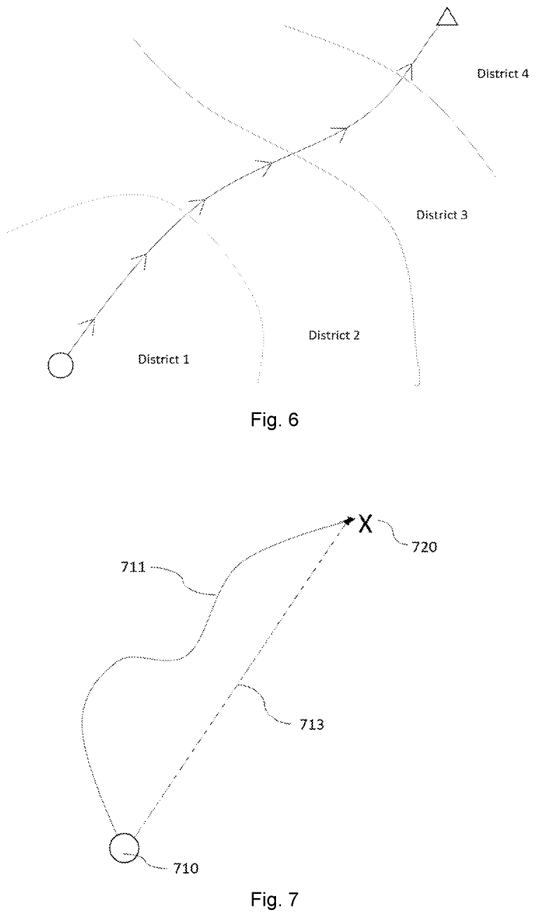

FIG. 6 shows a prospective trip 600 of a vehicle unit through districts 1 to 4. The prospective trip 600 of the vehicle unit commences at the start point 610 in district 1 and ends at the end point 620 in district 4. The vehicle unit also traverses districts 2 and 3 en route from the start point 610 to the end point 620.

Every delivery order has a starting point address which is the address of the origin, a destination address, a longitude and latitude of a pick-up location, and a longitude and latitude of a drop-off location. A compass pointer in degrees is calculated and used to group delivery orders “heading towards the same way” for the vehicle units. Those delivery orders within a time period for pick-up (starting from the time the first mile courier picks up from the origin address to the time the first mile courier loads it onto a vehicle unit) and a route in terms of the order of a lower level of hierarchy of coverage areas the vehicle unit passes through. For example, if the origin address and the destination address are in different districts, then the route is composed of the sub-districts the route passes through. Or, if the origin address and the destination address are in different sub-districts, then the route is composed of the neighbourhoods the vehicle unit passes through.

The system identifies correlated orders, or orders with a similar compass, originating in districts 2 and 3 heading to districts 3 and 4. The driver of the vehicle will be prompted to select those candidate jobs once the first job was selected. The system is equipped with a compass identifier. When a delivery order is inputted to the system, the compass identifier labels it with a “direction”. This flexibility allows for the design of delivery routes for the vehicle to maximally utilize its spare capacities along the whole trip. The system assumes the driver always like to end the whole trip close to where he or she starts from the beginning of the trip, unless the driver informs the system here he likes end the whole trip that day.

FIG. 7 shows a compass 713 calculated from the actual trip 711 of the vehicle. A compass 713 is a single degree number representing an order's direction using the origin address 710 and the destination address 720 or pick-up and drop-off locations of the agents, as compared to the actual trip of the delivery order by a vehicle.

### V. Operation of Multiple Vehicle Units With Multiple Couriers in a Neighbourhood

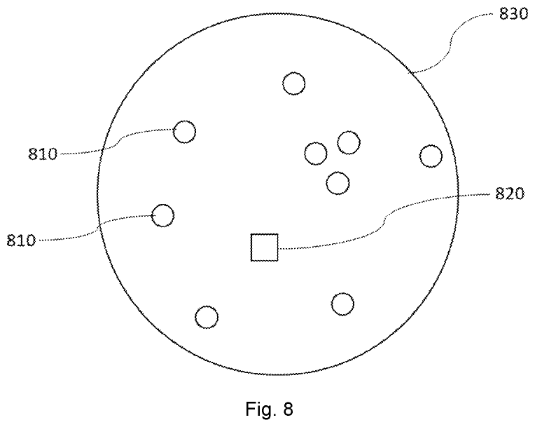

Referring to FIG. 8, which shows a distribution between a plurality of senders'addresses 810 and the recommended pickup point (i.e. first meeting point) 820 by the vehicle unit. In order to ensure a more efficient delivery, the vehicle unit of the present invention is not required to travel to each and every sender's address 810 to collect the shipment from the senders. Rather, the vehicle unit waits at the collection point 820 (given by the courier picking up at 810), where the first mile courier will collect the shipments from the respective origins'addresses 810 and deliver them to the vehicle unit at the pickup point 820. In an embodiment, there is a single collection point 820 within an area 820. Alternatively, there are multiple pickup points within an area that the vehicle unit is required to travel through all the pickup points in order to collect all the shipments for the delivery.

### VI. Delivery Order—3 Jobs, How Multiple Jobs Filtered and Displayed to Couriers and Vehicle Units

The processor of the present invention processes the delivery orders and each delivery order is broken down to three jobs. For example, the system will filter all the first mile jobs in all delivery orders received and select from them those which match with the availability profile a courier. The system suggests and displays to those suitable couriers the list of first mile jobs which can be accepted or refused by the couriers. These jobs are grouped into a bundle. In an embodiment, a bundle of jobs for a first mile courier is the group of filtered jobs within an area of a specific diameter such as 300 feet around the location of the first mile courier, which is the typically acceptable maximum walkable distance for most people at any one time. The bundle of jobs may require the first mile couriers to onload the shipments onto different vehicle units. In contrast, a bundle for a vehicle unit is the group of the filtered jobs within an area of a specific radius, such as of 500 meters, accessible by the couriers within a certain period of time. The area can be a predetermined prescribed area within the neighbourhood, or a floating area within the neighbourhood.

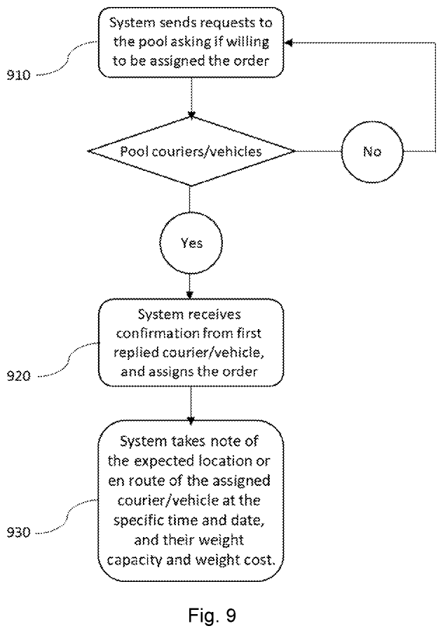

Referring now to the flowchart of FIG. 9 which shows a method for allocating the job of a particular order to a pool of eligible courier units and vehicle units at the same time. Upon receipt of a delivery order, the system's processor notes the required pick-up time from the origin address. Based on the courier availability profiles, the system filters the first mile jobs of the delivery order received and select those couriers whose profiles match the job, and show and display the job to all those matched couriers (couriers in the vicinity and have spare capacities). Once a courier accepts a job, the job will disappear from the other matched couriers'job list. Similarly, based on the vehicle unit availability profiles, the system filters the jobs of the delivery order received and select those vehicle units whose profiles match the job with the spare capacities, and with trips in a direction which match with the direction of the both with candidate orders with matched directions as decided by the system compass. Once a vehicle unit accepts a job, the job will disappear from the other matched vehicle units' job list. Subsequently, the system selects from its database the most suitable first mile and last mile couriers and vehicles that are capable of working in the specific area within the targeted delivery time. The processor then requests confirmation from the courier units and vehicle units by utilising a method comprising the following steps:
Step 910—The system sends a request to the courier units and vehicle units, inquiring as to their availability to undertake jobs within a specified area and within a specified time period. With regard to the courier units, the processor requests further information regarding their anticipated costs of the delivery, their available capacity, which is defined as their maximum capacity minus any weight of objects they have already transported, and their proximity to the origins'addresses. With respect to the vehicle units, the processor requests information regarding the expected delivery costs, the availability on the targeted delivery time, and the available capacity.
Step 920—Once the courier units and vehicle units have agreed to take up the jobs, the processor will confirm this with the first-responded courier units and vehicle units. The orders will then be assigned to the courier units and vehicle units that have expressed their availability. Nevertheless, should they indicate that they are unable to fulfil the jobs, the processor will once again select from the multitude of courier units and vehicle units.
Step 930—The system records the anticipated location and progress of the assigned courier/vehicle at the specified time and date, along with their weight capacity and associated costs.

### VII. Determining Meeting Points Among Couriers and a Vehicle Unit

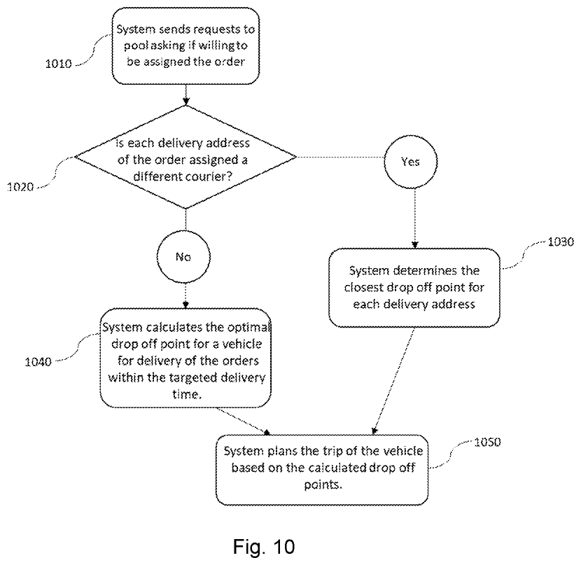

FIG. 10 shows a method for determining the meeting points with couriers (both first mile and last mile (i.e. the pickup points and drop-off points) of the vehicle units. As mentioned, the delivery orders are broken down into jobs and the jobs grouped to a plurality of bundles, which are groups of jobs within an area. For each bundle, the processor of the system computes the optimal or closest meeting points the vehicle units following the steps of:
Step 1010—send requests to the vehicle units requesting their availability to be allocated to the jobs,
Step 1020—consider whether each of the first mile job and last mile job in the respective delivery order is assigned to a different first mile courier and last mile courier,
Step 1030—If yes, determine the closest meeting point for each address, based on previously used meeting points or meeting points suggested by couriers within the vicinities.
Step 1040—If no, calculate the optimal meeting point for a vehicle unit based on the locations of the origins and destinations and the weight cost of the courier, where the weight cost is the cost or fee charged by the courier units per kilogram per hour.
Step 1050—Plans the prospective trip of the vehicle unit based on the calculated meeting points with the first mile and last mile courier.

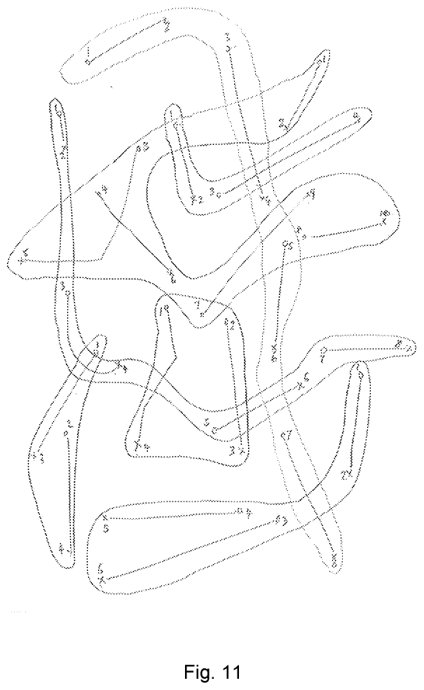

FIG. 11 shows a result of the planned prospective trips for different vehicle units, where x is the start point of a vehicle, or a pick-up point, and o is the end point, which is the meeting point with the last mile courier, or a drop-off point. The recommended prospective trip for a vehicle is indicated by an enclosed line, and the numbers indicate the order in which the system suggests each vehicle makes the stops, taking into the shortest path route planning based on the local traffic flow around the building clusters.

### VIII. How the System Completely Allocates All Jobs in Delivery Orders

In one embodiment, the system is further designed to, for the delivery orders received within a certain time interval, cater for a complete allocation of all order pick-ups and drop-offs points for one or more vehicle units, and the routing algorithm for “M (orders from M pick-up locations) to N (deliveries to N drop-off locations)”. M can include one or more transfer locations of shipments from other vehicle unit(s). N can include one or more transfer locations of shipments to other vehicle unit(s).

The system can allocate all order pick-ups and drop-offs for one or more vehicle units at different levels of a geographical hierarchy of the coverage area. More specifically, the geographical hierarchy is defined in a descending order from region, district, sub-district, neighbourhoods to building clusters. While the hierarchy is not used for managing a geographical distribution and allocation of the delivery orders like that in a typical fixed hub and spoke distribution system, it is used as a rule to switch the system into a different mode of calculations, labelling and projections. When there is very little demand of goods transfers, a higher hierarchy is used. When there is a lot of demand of goods transfers, a lower hierarchy is used.

When there is an unattended order or an unattended job of an order (i.e. one that no courier or vehicle unit select), either because there are no eligible couriers or vehicle units that the system would suggest and display such unattended job, or there are eligible couriers or vehicle units but the job is not selected, the system will automatically search for the next nearest couriers and vehicle units to consider selecting the job.

The system decides how wide a pool of couriers or vehicle units it would suggest and display a particular job for being selected by analysing the relative demand and supply of service (attending a job) within an area. The demand and supply of service is calculated using the density of a coverage area.

### IX. Coverage Area

In a further embodiment, the system determines the density of supply and demand by using coverage areas. The system creates a coverage area when:
(i.) A courier enters the system and creates a profile with the preferred distance to travel (e.g. no more than 300 feet in diameter), in which case the coverage area is a fixed circle with a diameter of 300 feet and centred on the location of the courier, and it moves when the courier shares the GPS location with the system and moves (a courier's coverage area);
(ii.) A vehicle unit enters the system and creates a profile with the preferred distance before loading of shipments (e.g. no more than 500 metres), in this case the coverage area is a fixed circle with a radius of 500 metres centred on the location of the vehicle unit, and it moves if the vehicle unit shares the GPS location with the system and moves (a vehicle unit's coverage area);
(iii.)An agent (i.e. either a courier or a vehicle unit) has entered the system's area to ‘shop’ for jobs for some delivery orders within a certain period of time. The system identifies the jobs of the delivery orders with the closest Euclidean distance to him or her around a specified starting location for a given time period. Unlike (i) and (ii), this is a coverage area with a changing radius (as delivery orders are added to or subtracted from the pool of delivery orders). (an agent's job selection coverage area);

A group of delivery order origin addresses or pickup points is analysed for density. The system calculates the centre of the group or the origin address of the delivery order. The longest Euclidean distance from an order within the group to this centre is the radius (order origin coverage area).

A group of delivery order destination addresses or drop-off locations is analysed for density or if there is an overlap with another delivery group. (order destination coverage area).

A group of couriers is analysed for density. The system calculates the centre of the group of couriers'locations (registered locations for a certain period of time or moving location shared by GPS). The longest Euclidean distance of a courier within the group to this centre of the group is the radius. (courier units coverage area).

The density of a group of vehicles is analysed. The system calculates the centre of the locations of the group of vehicle units (registered locations for a certain period of time or moving location shared by GPS). The longest Euclidean distance of a courier within the group to this centre of the group is the radius. (vehicle units coverage area).

The system uses the densities to calculate whether there is sufficient delivery capacity in a particular area, and to determine whether the designation of a particular origin or destination area is by region (e.g. New Territories East), district (e.g. Sai Kung), sub-district (e.g. Sai Ying Pun) or neighbourhood (e.g. name of a street or estate). The delivery order furthest from the agent's designated starting point is the radius of this coverage area, and the density of this coverage area is the number of orders divided by the radius of the coverage area.

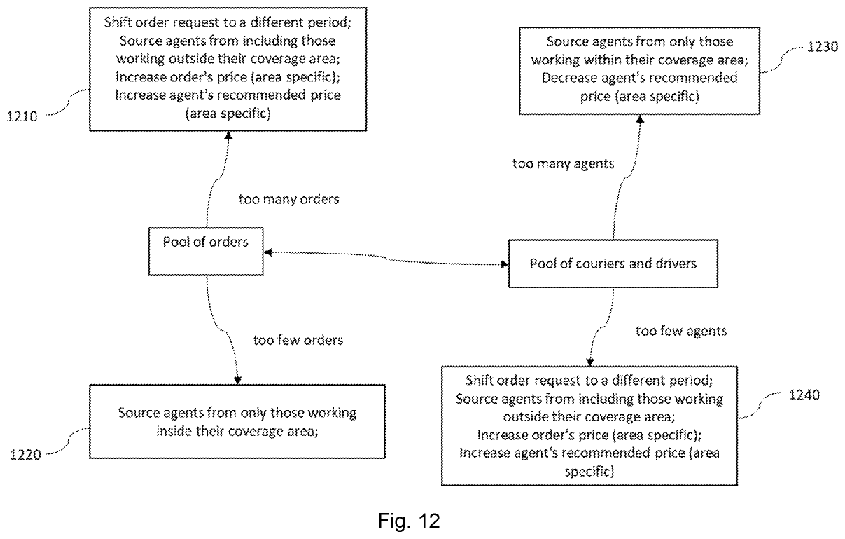

FIG. 12 illustrates the balancing of order supply and demand. If there are too many orders 1210, the system shifts the order request to another period, sources the couriers and vehicle units also from those working outside their coverage area, increases the price of the order (area specific), increases the recommended price of the couriers and vehicle units. If there are too few orders 1220, the system will only source the couriers and vehicle units from those working within its coverage area.

Similarly, if there are too many couriers and vehicle units 1230, the system only sources the couriers and vehicle units from those working within their coverage area and decreases the agent's recommended price. If there are too few couriers and vehicles 1240, the system moves the order request to another period, sources the couriers and vehicles also from those working outside its coverage area, increases the order price and increases the agent's recommended price.

A coverage area's size is determined by relative demand of goods transfer in numbers and weights to the supply of transfer capacities in the available vehicle units. A coverage area can be an order origin coverage area or an order destination coverage area. An order origin coverage area is, visually or conceptually, a circle including all the eligible delivery orders'registered origin addresses (first-time use), or the pick-up locations (not the first-time use), centred around an available vehicle unit in its origin area, and the demand of goods transfer in the order origin coverage area is equal to or less than the vehicle capacity. An order destination coverage area is a smallest circle including all the eligible delivery orders' registered destination addresses (first-time use), or the drop off locations (not the first-time use), centred at a point in the midst of the delivery addresses or drop-off locations. A coverage area's size is used to determine the geographical denomination level for the origin and the destination. For example, if the coverage area covers more than one districts, the denomination is region. Or, if the coverage area covers more than one sub-district, the denomination is district. An eligible delivery order is one that is suitable for a vehicle unit to consider accepting picking-up. It is either orders to be picked up around the location of the vehicle unit, or orders within the same destination coverage area of one or more of the orders the vehicle unit has picked, and are picked up along the vehicle unit's route (identified by the compass) if he has an existing route, or if he has started picking some jobs of order deliveries following a certain route. One use of the hierarchy system, is to help the first mile courier users see in the system the description of destination of a vehicle unit is heading to.

An inverse of a coverage area density is the size of the circle divided by the number of locations within the circle. If there is only one location, the density is zero. The processor can only handle numbers that are not infinite, so all calculations are performed using the inverse of the coverage area density rather than the coverage area density itself.

More specifically, the system is equipped and specifically designed to overcome the problems in the traditional methodology in route-planning systems. The traditional or conventional transportation and routing systems nowadays use Euclidean distance methodology or alike to arrange the order of the pick-up and drop-off locations of a vehicle unit. The technical improvement is that the arrangement of the order of pick-up or drop-off locations is based on an ordered route of building clusters. One advantage is that it would not lead to vehicle units travelling unnecessarily far distances or making unnecessary U-turns or illegal U-turns. The improvement is due to two reasons of the system design: (i) the addresses in the database are grouped in building clusters defined by the streets and roads surrounding them; (ii) the database of addresses has an identification if the building is appropriate for a tag-along courier, a non-tag-along courier or either. A tag-along courier is one who will travel with the vehicle unit for a part or the whole of a prospective trip of the vehicle unit.

The invention here allows the delivery orders from one sender to be arranged in more than one vehicle unit heading to a different route, or arrange orders from different senders heading towards similar or nearby districts or neighbourhoods in the same vehicle unit. The pick-up and drop-off locations here are chosen based on:
(i.) the preferred route indicated by a vehicle unit,
(ii.) the spare capacity of the vehicle unit,
(iii.) the amount or volume of shipments to be transferred,
(iv.) the order of each pick-up followed by the respective drop-off; and
(v.) the minimum distance travelled by the vehicle unit.

### X. How the System Tracks the Performance of the Couriers and Vehicle Units

According to an embodiment of the present invention, the system tracks the performance of couriers and vehicle units. It decides which assigned jobs are grouped into bundled jobs to be selected by a courier or vehicle unit. For each courier, the system only calculates their performance on the job that is to be delivered immediately. There are occasions when a courier picks up a job but decides to load it onto a vehicle unit later, or when a courier picks up a job from a vehicle unit but delivers to the destination at a predetermined time. Only the express service would require courier units and vehicle units to carry out the jobs immediately.

The courier's performance is based only on the time and location of the pick-up points and the origin address or the drop-off point and the destination address, marked by the synchronisation of the signals from the communication tools between the agent and the vehicle unit or the sender. The registered address within the database of registered building addresses would indicate:
(i.) the type of access to the building (e.g. for non-tag along courier units and vehicle units only, for tagged courier units and vehicle units only, open)
(ii.) the type of access to upper floors (e.g. walk-up flat, lifts)
(iii.) the need for registration for delivery staff at the door
(iv.) the system that uses statistical analysis to calculate the performance of the delivery of a building by different couriers:
(v.) moving or walking speed
(vi.) speed of climbing/descending stairs
(vii.) speed of lifts

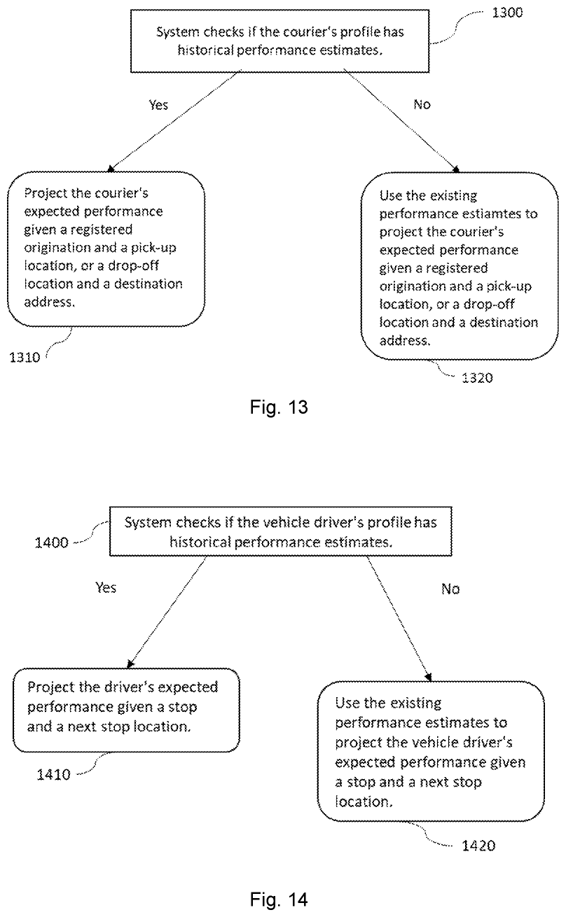

FIG. 13 shows a graph illustrating the tracking of courier performance by an embodiment of the system. At step 1300, the system checks whether the courier's profile has historical performance estimates. If yes-1310, the system projects the courier's expected performance given a registered origin and pick-up location or drop-off location and destination address. If no-1320, the system uses the existing performance estimates to project the courier's expected performance given a registered origin and pick-up location or drop-off location and destination address.

For each vehicle unit, the system calculates his vehicle performance in terms of speed between stops and time spent at each stop. The vehicle unit's moving performance is based only on the times (and some time, the longitude and latitude location) and location of the meeting points with other courier units and vehicle units, marked by the synchronisation of the signals from the communication tools between the other courier units and vehicle units. The vehicle unit's stopping performance (time spent at a stop) is based only on the GPS exchange with the vehicle unit and the location of the stop.

The system then used statistical analysis to calculate a vehicle unit's delivery performance:
(i.) moving speed on the motorway
(ii.) driving speed on local roads
(iii.)waiting time per stop

FIG. 14 shows a graph illustrating the tracking of vehicle unit performance by an embodiment of the system. In step 1400, the system checks whether the courier's profile has historical performance estimates. If yes—1410, the system projects the courier's expected performance given a registered origin and pick-up location or drop-off location and destination address. If no—1420, the system uses the existing performance estimates to project the courier's expected performance given a registered origin and pick-up location or drop-off location and destination address.

In an embodiment of the present invention, the system is capable of comparing the collective performance of a courier and a vehicle unit at different meeting points (pick-up points, drop-off points). The system decides which meeting point to recommend to the vehicle unit and courier if:
(i.) such a meet-up point falls within the courier's coverage area (e.g. 300 feet in diameter) centred on the originally suggested meeting point;
(ii.) the collective performance of the vehicle unit from the meeting point to the next stop and the courier between the new meeting point and the registered address improves; and
(iii.) performance is measured in terms of cost.

The cost of a vehicle unit is the expected fuel cost for the traffic flow distance from one stop to the next, and the time cost of the vehicle unit for the difference in the expected time for the vehicle unit to travel to the next stop.

A courier's cost is the courier's time cost for the difference in the expected time for the courier to travel from the new meeting point to the suggested meeting point. The recommendation is made when a prospective vehicle trip is created, but before the final confirmation of a prospective trip to become a confirmed vehicle trip. The recommendation is made with a monetary adjustment suggestion to both the vehicle driver and the courier before they both accept and confirm.

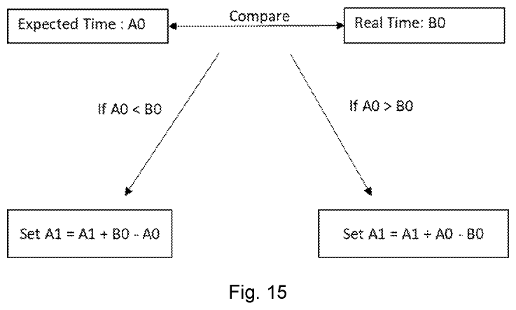

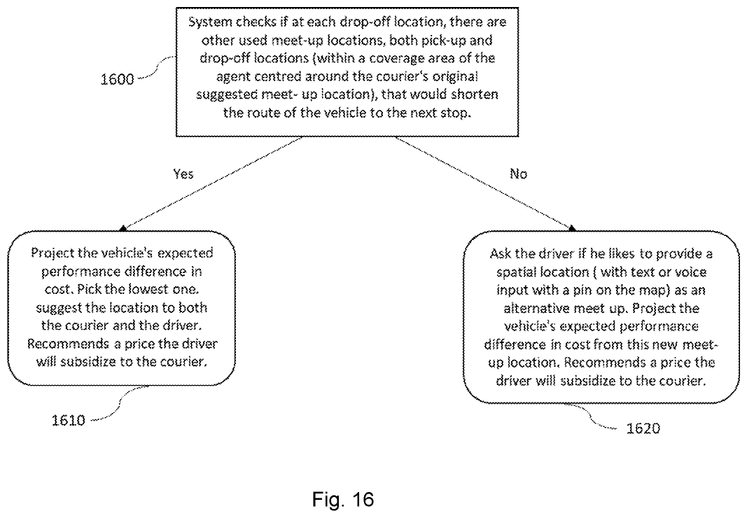

FIG. 15 illustrates the time management plan for courier units and vehicle units, together with an assessment of the uncertainty of traffic conditions at different times. The expected time AO is compared to the actual time of the vehicle arriving at a subsequent stop. If A0<B0, the vehicle is off schedule and the system updates the new expected time A1 to A1+B0—A0. Alternatively, if A0>BO, the vehicle is ahead of schedule and the new Expected Time A1 of the vehicle is updated to A1+A0−B0.

In a further embodiment, the system compares the actual performance of vehicle units (and courier units) with the expected performance and updates the last updated expected time at each stop of a confirmed trip.

The system updates the expected meeting and arrival time for all subsequent stops in the confirmed trip if:
(i.) the real time at a meeting stop is ahead of schedule
(ii.) the real time at a meeting stop is behind schedule

The system will also take note of the absolute time taken to complete the route at that time period and the magnitude of the deviation of the actual time from the expectation for that time period and route.

### XI. Floating Spokes

In another embodiment, the system is designed with changing suggestion of some pick-up and drop-off locations of first mile couriers and last mile couriers, or grouping suggestion of some pick-up or drop-off locations, including a location not suggested by the couriers associated with the trip, but either used before by other couriers, or suggested by the vehicle unit if the system does not have such location, due to enhanced overall operational efficiency of the vehicle unit delivery trip and the associated delivery order jobs linked to the trip.

This specific feature minimizes the usage of road by rearranging some pick-up and drop-off locations to other existing ones or used ones by others but not suggested by any courier associated with the vehicle trip, with the result that the overall cost of operation is lower or time of operation is shorter. This can happen when, for example, there is a high usage of the system, and that the transit times with the many couriers (with lower capacity of goods transfer than a goods vehicle) with lower speed of transfer would be more than the delivery time for each of the couriers. Or, this can happen when certain route of the vehicle unit, due to the traffic flow, would be much longer, if the couriers' locations, which are close to each other in Euclidean distance terms, are not changed.

FIG. 16 shows the floating spoke location selection recommendation. At step 1600, the system checks whether there are other used meeting points at each pick-up and drop-off locations (within a courier coverage area centred around the courier's original proposed meeting point), that would shorten the vehicle unit's trip to the next stop. If yes—1610, the system projects the expected difference in cost of the vehicle unit's performance. Suggests the location to both the courier and the vehicle unit. Recommends a price that the vehicle unit will subsidise to the courier. If no—1620, the system asks the vehicle unit if they would like to provide a physical location (using text or voice input with a pin on the map) as an alternative meeting point. Project the expected cost difference in the vehicle unit's performance from this new meeting location. Recommends a price that the vehicle unit will subsidise the courier.

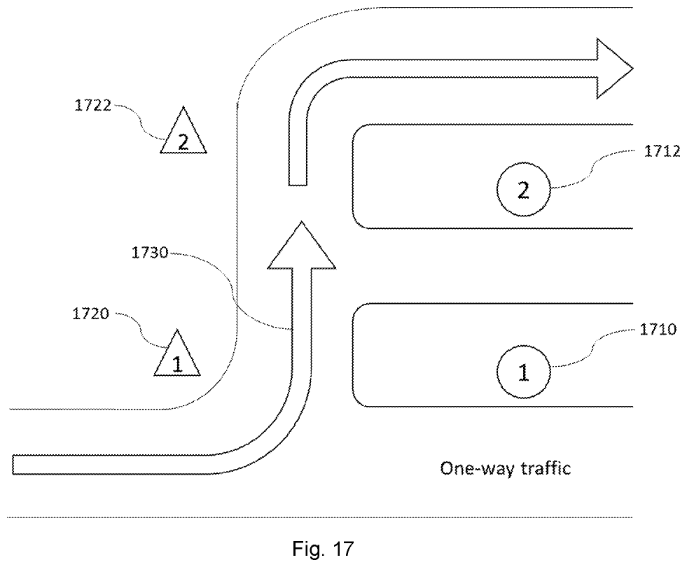

By way of illustration, an example of the benefits of the current system design is shown in FIG. 17. FIG. 17 shows an actual traffic situation where the three side streets are one-way. If the pick-up and drop-off points are set to 1710 and 1712, the vehicle unit will have to enter the same road at least twice to reach both couriers, which is time consuming. In contrast, the system of the present invention calculates and proposes new pick-up and drop-off points based on clusters defined by the actual street layout. As shown in FIG. 17, the system proposes that courier 1 moves to position 1720 and courier 2 moves to position 1722 so that the vehicle unit only has to travel a single trip 1730 to complete the delivery task, saving time and money.

### XII. Floating Hub

In another embodiment, the system is designed with the “floating hub system design”.

This feature is the calculation of the minimization of the total distances travelled by two or more vehicle units from different originating regions, districts or neighbourhoods that are delivering to a same region, district or neighbourhood.

The identification of a shipment transfer between two vehicles is done with a two-dimensional matrix that represents the cost of transfer from an originating region, district or neighbourhoods on one axis to the destination region, district or neighbourhood on the other axis. This cost number can be simple count indicating the cost to cross from one region to its neighbouring region in terms of travel time, tunnel fee or petrol cost.

The calculation is done when one or more vehicles have indicated to accept certain jobs. A prospective trip is formed with a profile of the vehicle unit, the trip in terms of the order of districts or subdistricts the vehicle unit pass through from the starting point to the end point, the expected time schedule at each stop, and the list of job order numbers.

Visually, or conceptually, each prospective trip's destination coverage area's circle is drawn on a map around the destination district, sub-district, neighbourhood or building clusters. When there are overlaps of two circles, a bigger circle is created to include those two overlapping circles, and the bigger circle's density is calculated incorporating all the locations in the overlapping circles. The bigger circle's density number as a quotient to the average of the overlapping circles densities is a measure of the efficiency improvement.

Once the system has identified the overlap of destination coverage area circles, it will check whether at least one vehicle unit has sufficient spare capacity to carry the other vehicle unit's shipments within the destination coverage area. If this is the case, the system will check with each of the vehicle units whether they would like to meet to transfer some goods, and the savings in time, extra earnings or fuel costs which will happen because of the transfer. The system will select the vehicle unit with the densest destination coverage area to do the job. The system will then suggest a used location along the intersection of their trips, or somewhere close to both of their trips, so that the total distance travelled by both is minimised. A used location (a “vehicle transit location”) is suggested within a district or sub-district along their respective trips. The used location, or a centre of the district or sub-district if no such location is available, will be used to calculate the expected schedule and location of stops for the two vehicle units'prospective trips. If no such location is available, the system will ask each of the vehicle units for their suggestion. When both confirm, the new prospective trips are created in the prospective trip pool.

The system ranks the size of the circles in the destination coverage area, starting with the larger circles and working down to the smaller ones. (Larger circles mean greater potential savings on the distance travelled). The system also groups the extra locations together with the first group and calculates a new trip by connecting all the nodes with the shortest path.

A linear programming calculation is used to identify the combination of transits, which is a matrix variable of transit locations and the amount of shipment transfer at the locations between the vehicle units.

The advantage of this invention over existing fixed hub-and-spoke systems is that there are no fixed costs of dedicated infrastructure or sites to set up in the first place. As a result, this overall system can be deployed in any region or new city with very low set up costs. The desired effect of this innovation is to improve the efficiency factor of road use and the convenience factor of road users.

In another embodiment, the system compares the collective performance of a vehicle unit and another vehicle unit (both with prospective trips formed but no confirmed trip yet formed) travelling to the same area, if they exchange some stops (and goods to be unloaded at those stops), where performance is measured in terms of cost. The system decides which meeting point should be recommended to both vehicle units if:
(i.) such a meeting point has been used previously by other courier units and vehicle units and falls within the vehicle units'trips (e.g. 500 metres in diameter) centred around the original stops suggested by either the system (accepted and confirmed floating spoke adjustments) or the couriers.
(ii.) One or both vehicle units suggest a new meeting point for the recommended transfer after accepting the recommendation.

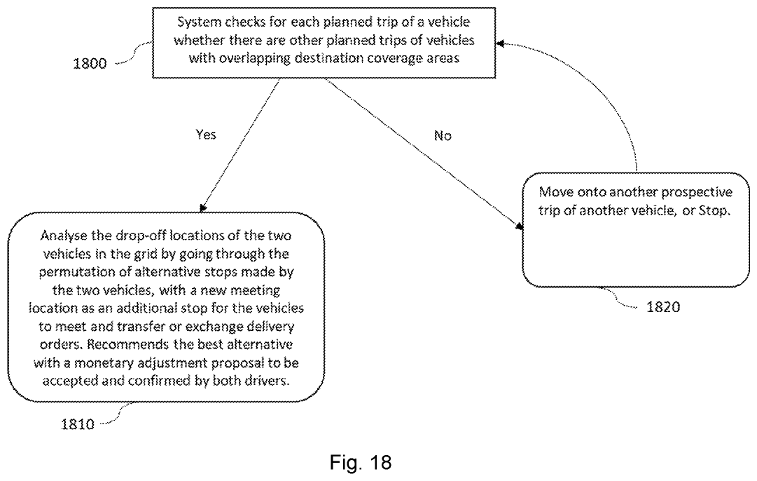

The recommendation is made when a prospective trip of a vehicle unit is formed, but before the final confirmation of a prospective trip to become a confirmed trip of the vehicle unit. The recommendation is made with a monetary adjustment proposal to both vehicle units before they both accept and confirm. FIG. 18 shows the recommendation of the floating hub location. In step 1800, for each prospective trip of a vehicle unit, the system checks whether there are other prospective trips of vehicle units with overlapping target coverage areas. If yes—1810, the system analyses the drop-off locations of the two vehicle units in the grid by going through the permutation of alternative stops travelled by the two vehicle units, with a new meeting location as an additional stop for the vehicle units to meet and transfer or exchange delivery orders, and recommends the best alternative with a monetary adjustment proposal to be accepted and confirmed by both vehicle units. If no—1820, the system moves to another prospective trip of another vehicle unit or stop.

The system monitors the historical performance of couriers and vehicle units in terms of the time used for each trip and each job of first-mile and last-mile delivery. The capacity to deliver for each neighbourhood is determined based on the aggregate capacities of first or last mile couriers whose preferred place to work is within the neighbourhood. When demand of delivery to the neighbourhood exceeds (or cannot meet) the delivery capacities of the first or last-mile couriers within the neighbourhood, the system would advise the couriers within the neighbourhood to increase (decrease) cost or consider working longer (shorter) periods.

Likewise, the capacity to deliver for each region or district is determined based on the aggregate capacities of vehicle units whose preferred route or district to work is within the district. When demand of delivery to the district exceeds (or cannot meet) the delivery capacities of the vehicle units within the district, the system would advise the vehicle units chosen to travel to the district to increase (decrease) cost or consider working longer (shorter) periods. The foregoing disclosure of specific embodiments is intended to be illustrative of the broad concepts comprehended by the invention.

1. A logistics management system, comprising:
(i) an input unit adapted for inputting delivery information of at least one order, wherein the delivery information of the order include at least a first location and a second location, and
(ii) a processor in operative communication with the input unit, adapted to confirm availability with a plurality of courier units and a plurality of vehicle units, and recommend a delivery route for the order based on a correlation between the delivery information of the order and the availability of the plurality of courier units and the plurality of vehicle units, wherein the plurality of courier units further comprise a plurality of first mile couriers and a plurality of last mile couriers,
wherein the delivery route comprises a first mile courier for collecting a shipment from the first location, a vehicle unit for receiving the item from the first mile courier and transporting the shipment, and a last mile courier for delivering the shipment from the vehicle unit to the second location.

2. The logistics management system according to claim 1, wherein the delivery route includes at least a first delivery route for a first order and a second delivery route for a second order,
wherein a first vehicle unit of the first delivery route is identical to a second vehicle unit of the second delivery route, and/or a first first mile courier of the first delivery route is identical to a second first mile courier of the second delivery route, and/or a first last mile courier of the first delivery route is identical to a second last mile courier of the second delivery route.

3. The logistics management system according to claim 1, wherein the processor is adapted to allocate a predetermined first mile courier and a predetermined last mile courier to the order, based on the availability of the plurality of courier units within a predetermined period of time.

4. The logistics management system according to claim 1, wherein the processor is adapted to classify the order into a first bundle based on the first location and a second bundle based on the second location, wherein each of the first and second bundles comprises at least one order with the first location or the second location located within a predetermined geographical area.

5. The logistics management system according to claim 4, wherein the predetermined geographical area is in a size defined by a pre-determined diameter.

6. The logistics management system according to claim 5, wherein the pre-determined diameter is 300 feet.

7. The logistics management system according to claim 4, wherein the pre-determined geographical area is in a size accessible by the plurality of the courier units within a predetermined period of time.

8. The logistics management system according to claim 4, wherein the geographical area comprises a first geographical area and a second geographical area, wherein the processor is adapted to allocate a predetermined vehicle unit to travel between at least the first geographical area and the second geographical area, and the vehicle unit is allocated to onload at least one shipment from at least one first mile courier at the first geographical area and to offload at least one shipment to at least one last mile courier at the second geographical area.

9. The logistics management system according to claim 8, wherein the processor is adapted to determine one or more pick-up points where the vehicle unit onloads the at least one shipment from the at least one first mile courier, and one or more drop-off points where the vehicle unit offloads the at least one shipment to the at least one last mile courier.

10. The logistics management system according to claim 9, wherein locations of the one or more pick-up points and drop-off points are determined by traffic data and/or road layout.

11. The logistics management system according to claim 10, wherein locations of the one or more pick-up points and drop-off points are determined based on pre-used locations stored within the system.

12. The logistics management system according to claim 1, wherein the system is adapted to assign a compass number for the order, wherein the compass number represents a direction of the second location relative to the first location.

13. The logistics management system according to claim 12, wherein the system is adapted to allocate the vehicle unit to onload at least two shipments assigned with the same compass number.

14. The logistics management system according to claim 1, wherein the at least one order includes a first order and a second order, and the processor is adapted to allocate a first prospective trip to a first vehicle unit for the first order and a second prospective trip to a second vehicle unit for the second order,
wherein the processor is further adapted to revise the first and second prospective trips in response to predetermined conditions, by arranging the first and second vehicle units to meet at a predetermined meeting point where at least one shipment is transferred from the first vehicle unit to the second vehicle unit.

15. The logistics management system according to claim 14, wherein the predetermined conditions are selected from change in traffic conditions, capacities of the vehicle units, or a combination thereof.

16. The logistics management system according to claim 1, further comprising an output unit adapted to output a respective prospective trip to each of the plurality of courier units and the plurality of vehicle units.

17. The logistics management system according to claim 1, wherein the input unit is adapted for the plurality of courier units and the plurality of vehicle units to update their respective availability.

18. The logistics management system according to claim 1, wherein the delivery information of the order further includes weight, size, sender information, recipient information, expected pickup time, expected delivery time, monetary value, or a combination thereof.

19. The logistics management system according to claim 1, wherein each of the plurality of courier units is a person, a robot or a drone.

20. The logistics management system according to claim 1, wherein each of the plurality of vehicle units comprises one or more vehicles of transport modes selected from air, marine transport, land, or a combination thereof.

21. The logistics management system according to claim 20, wherein the one or more vehicles are selected from a group of a van, an automobile, a bus, a ship, an airplane, a train, a truck, a bicycle, a motorcycle, a helicopter, a drone, or a combination thereof.

22. The logistics management system according to claim 20, wherein each of the one or more vehicles has a coverage area defined by a predetermined radius.

23. The logistics management system according to claim 22, wherein the predetermined radius is 500 m.

24. The logistics management system according to claim 20, wherein the vehicle unit comprises at least a first vehicle and a second vehicle, wherein the processor is adapted to arrange the first and second vehicles to meet for the shipment to be transferred from the first vehicle to the second vehicle.

25. The logistics management system according to claim 1, wherein the system is accessible via an internet.

26. A logistics management method, comprising steps of:
(i) inputting delivery information of at least one order, wherein the delivery information of the order include at least a first location and a second location;
(ii) confirming availability with a plurality of courier units and a plurality of vehicle units, wherein the plurality of courier units include a plurality of first mile couriers and a plurality of last mile couriers; and
(iii) recommending a delivery route for the order, by correlating the delivery information of the order and the availability of the plurality of courier units and the plurality of vehicle units;
wherein the delivery route comprises a first mile courier for collecting a shipment from the first location, a vehicle unit for receiving the shipment from the first mile courier and transporting the shipment, and a last mile courier for delivering the shipment from the vehicle unit to the second location.

27. The logistics management method according to claim 26, wherein the delivery route includes at least a first delivery route for a first order and a second delivery route for a second order,
wherein a first vehicle unit of the first delivery route is identical to a second vehicle unit of the second delivery route, and/or a first first mile courier of the first delivery route is identical to a second first mile courier of the second delivery route, and/or a first last mile courier of the first delivery route is identical to a second last mile courier of the second delivery route.

28. The logistics management method according to claim 26, further comprising a step of allocating a pre-determined first mile courier and a predetermined last mile courier to the order, based on the availability of the plurality of courier units within a predetermined time period.

29. The logistics management method according to claim 26, further comprising a step of grouping the order into a first bundle based on the first location and a second bundle based on the second location, wherein each of the first and second bundles comprises at least one order with the first location or the second location located within a predetermined geographical area.

30. The logistics management method according to claim 29, wherein the predetermined geographical area is in a size defined by a pre-determined diameter.

31. The logistics management method according to claim 30, wherein the pre-determined diameter is 300 feet.

32. The logistics management method according to claim 31, wherein the pre-determined geographical area is in a size accessible by the plurality of courier units within a predetermined period of time.

33. The logistics management method according to claim 26, wherein the geographical area comprises a first geographical area and a second geographical area, the method further comprising a step of allocating a predetermined vehicle unit to travel between at least the first geographical area and the second graphical area, wherein the vehicle unit is allocated to onload at least one shipment from at least one first mile courier at the first geographical area and to offload at least one shipment to at least one last mile courier at the second geographical area.

34. The logistics management method according to claim 33, further comprising a step of determining one or more pick-up points where the vehicle unit onloads the at least one shipment from the at least one first mile courier, and one or more drop-off point where the vehicle unit offloads the at least one shipment to the at least one last mile courier.

35. The logistics management method according to claim 34, further comprising a step of interactively suggesting locations of the one or more pick-up points and drop-off points based on traffic data and/or road layout.

36. The logistics management method according to claim 35, further comprising a step of suggesting the locations of the one or more pick-up points and drop-off points are determined based on pre-used locations stored within the system.

37. The logistics management method according to claim 26, further comprising a step of assigning a compass number for the order, wherein the compass number represents a direction of the second location relative to the first location.

38. The logistics management method according to claim 37, further comprising a step to allocate the vehicle unit to onload at least two shipments assigned with the same compass number.

39. The logistics management method according to claim 26, wherein the at least one order includes a first order and a second order, and a first prospective trip is allocated to a first vehicle unit for the first order and a second prospective trip is allocated to a second vehicle unit for the second order,
wherein the method further comprising a step of revising the first and second prospective trips in response to predetermined conditions, by arranging the first and second vehicle units to meet at a predetermined meeting point where at least one shipment is transferred from the first vehicle unit to the second vehicle unit.

40. The logistics management method according to claim 39, wherein the predetermined conditions are selected from change in traffic conditions, capacities of the vehicle units, or a combination thereof.

41. The logistics management method according to any claim 26, further comprising a step of outputting a respective recommended route to each of the plurality of courier units and vehicle units.

42. The logistics management method according to claim 26, wherein the delivery information of the order further include weight, size, sender information, recipient information, expected pickup time, expected delivery time, monetary value, or a combination thereof.

43. The logistics management method according to claim 26, wherein each of the plurality of courier units is a person, a robot or a drone.

44. The logistics management method according to claim 26, wherein each of the plurality of vehicle units comprises one or more vehicles of transport modes selected from air, marine transport, land, or a combination thereof.

45. The logistics management method according to claim 44, wherein the one or more vehicles are selected from a group of a van, an automobile, a bus, a ship, an airplane, a train, a truck, a bicycle, a motorcycle, a helicopter, a drone, or a combination thereof.

46. The logistics management method according to claim 44, wherein each of the one or more vehicles has a coverage area defined by a predetermined radius.

47. The logistics management method according to claim 46, wherein the predetermined radius is 500 m.

48. The logistics management method according to claim 26, wherein the vehicle unit comprises at least a first vehicle and a second vehicle, wherein the method further comprising a step of arranging the first and second vehicles to meet for the shipment to be transferred from the first vehicle to the second vehicle.
